(19) United States
(12) Patent Application Publication
(10) Pub. No.: US 2008/0257753 A1
(43) Pub. Date: Oct. 23, 2008

(54) Grey Water Filtering System

(76) Inventor: Michael John Burton, North Cornwall (GB)

Correspondence Address: FAY SHARPE LLP, 1100 SUPERIOR AVENUE, SEVENTH FLOOR, CLEVELAND, OH, 44114, US

(21) Appl. No.: 11/658,782

(22) PCT Filed: Jul. 14, 2005
(86) PCT No.: PCT/GB2005/002762

§ 371 Date: Feb. 19, 2008

(30) Foreign Application Priority Data
Jul. 15, 2004 (GB) 0415869.7

(51) Int. Cl. C02F 1/28; C02F 1/00; C02F 1/461

(52) U.S. Cl. 205/742; 210/490; 210/767; 210/500.1

(57) ABSTRACT

A method for filtering grey water for recycling includes passing grey water to be filtered through a filter assembly, including a support mesh or blanket holding a sedimentary material produced by electrolysis of sea water. A filter assembly can include a perforated filter plate and at least one mesh or blanket member supported by the filter plate which holds a sedimentary material produced by electrolysis of sea water.

This invention relates to a method and apparatus for filtering grey water for recycling purposes, and also to a method of producing a filtering medium and to a filtering medium produced by the method of the invention.

According to a first aspect of the present invention, there is provided a method of filtering grey water for recycling, which comprises passing the grey water to be filtered, through a filter assembly including a support blanket holding a sedimentary material produced by electrolysis of sea water.

A further aspect of the present invention provides a filter assembly including a cylindrical housing, a perforated filter plate and at least one mesh or blanket member supported by the filter plate, which holds a sedimentary material produced by electrolysis of sea water. Preferably the mesh or blanket comprises nylon wadding.

A further aspect of the invention provides a method of producing a filter medium for filtering grey water for recycling, the method comprising subjecting sea water to a process of electrolysis using at least one copper anode, and an iron cathode, whereby a sediment is produced which can be utilised with a suitable support means, to form a filter medium.

In a typical application, a volume of approximately five gallons of sea water is subjected to a potential of 12 volts, which causes a current of 3.5 to 4.5 amps to flow between the electrodes. After about four hours, a sedimentary material is produced, which can be applied to a filter blanket.

A further aspect of the present invention provides a filter medium for filtering grey water comprised of paratacamite, acamite, or botallackite.

A further aspect of the present invention provides a method of filtering grey water for recycling, which comprises passing grey water to be filtered, through a filter assembly including a support mesh or blanket holding paratacamite, acamite or botallackite.

A further aspect of the present invention provides a filter medium for filtering grey water, comprised of (Cu₂OH)₃Cl.

A further aspect of the present invention provides a filter medium for filtering grey water, comprised of CuCO₃ and Cu(OH)₂.

A further aspect of the present invention provides a method of producing a filter medium for filtering grey water for recycling, comprising subjecting an aqueous solution containing chloride ions to electrolysis using at least on copper anode.

Some embodiments of the invention will now be described by way of example, with reference to the accompanying drawings in which:

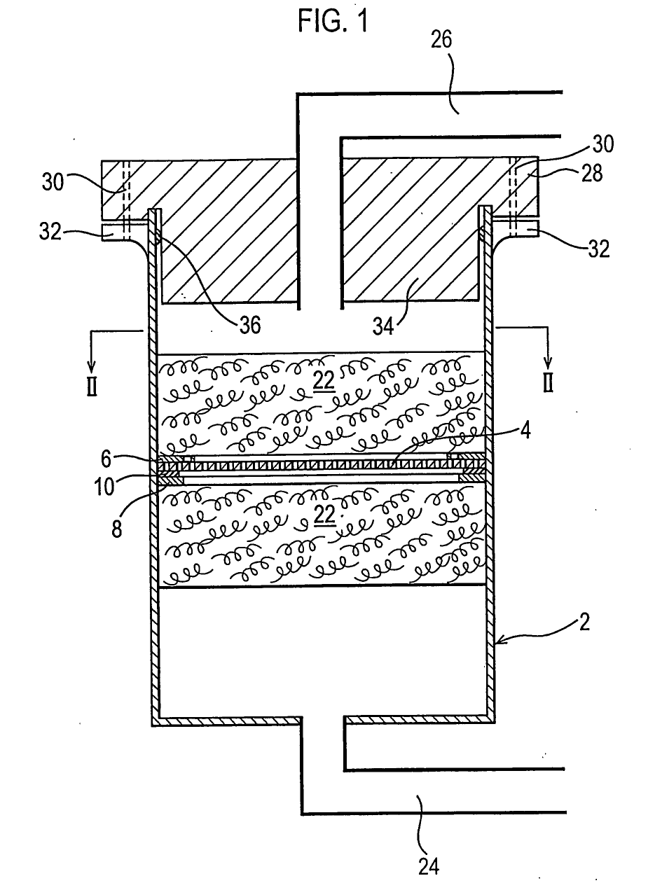

FIG. 1 is an axial cross-section through the body of a filter according to the present invention;

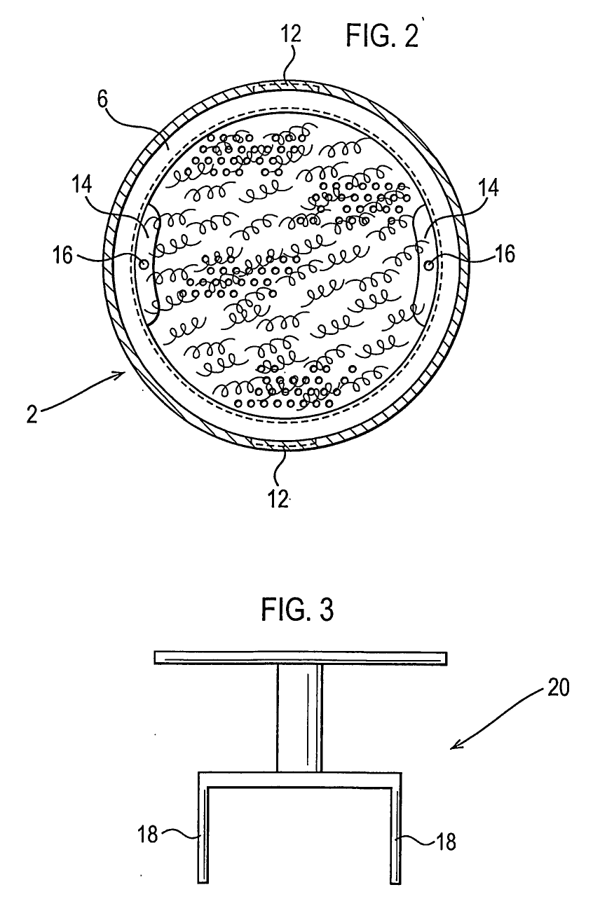

FIG. 2 is a cross-section along the line II of FIG. 1, taken perpendicular to the axis of the body;

FIG. 3 is a schematic view of an assembly tool for the filter plates of the device;

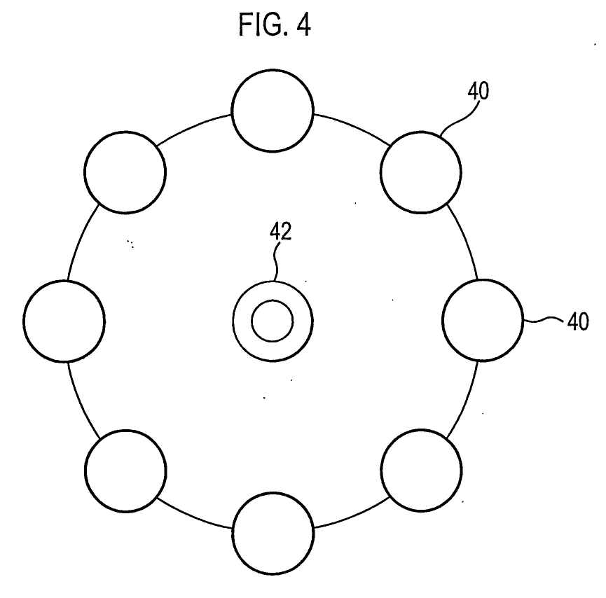

FIG. 4 is a plan view of an arrangement of electrodes for an electrolysis apparatus;

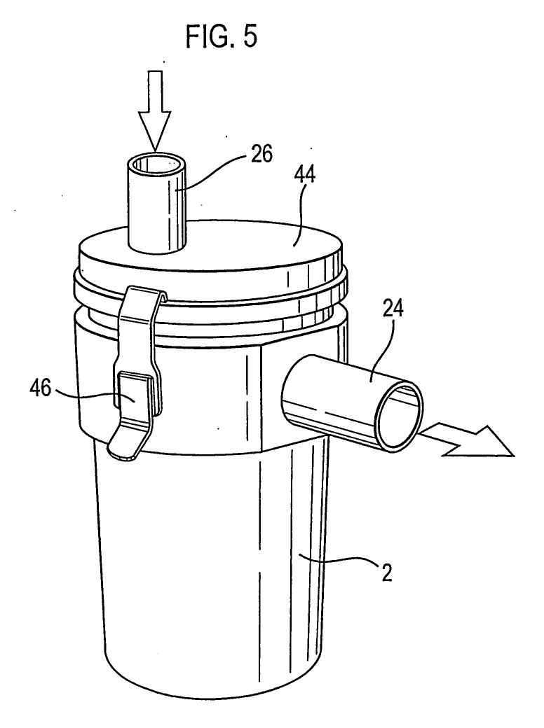

FIG. 5 is a perspective view of a filter apparatus;

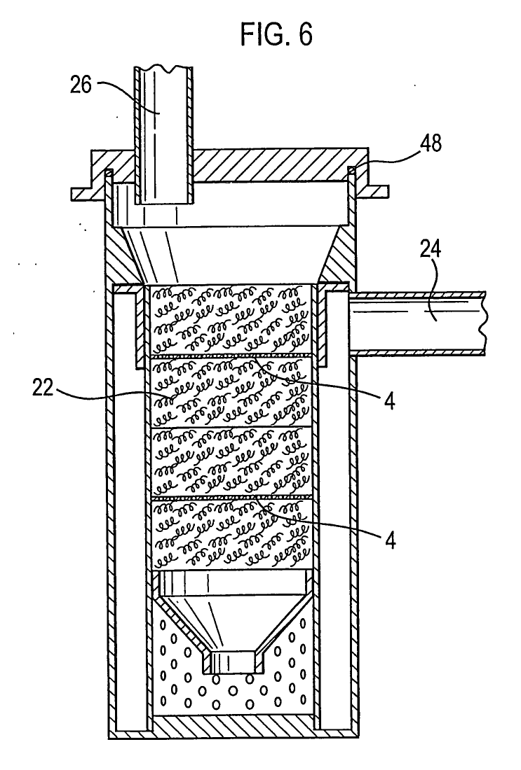

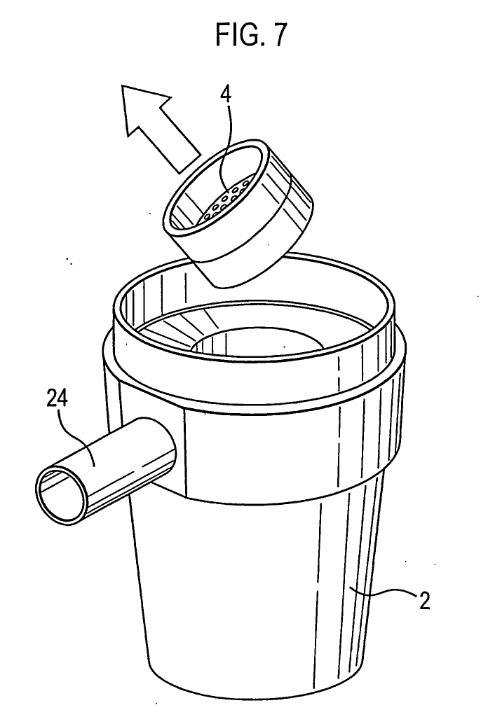

FIG. 6 is an axial cross-section through the filter apparatus shown in FIG. 5;

FIG. 7 is a perspective view of the filter apparatus shown in FIG. 5 with its cap removed and a filter plate shown during replacement;

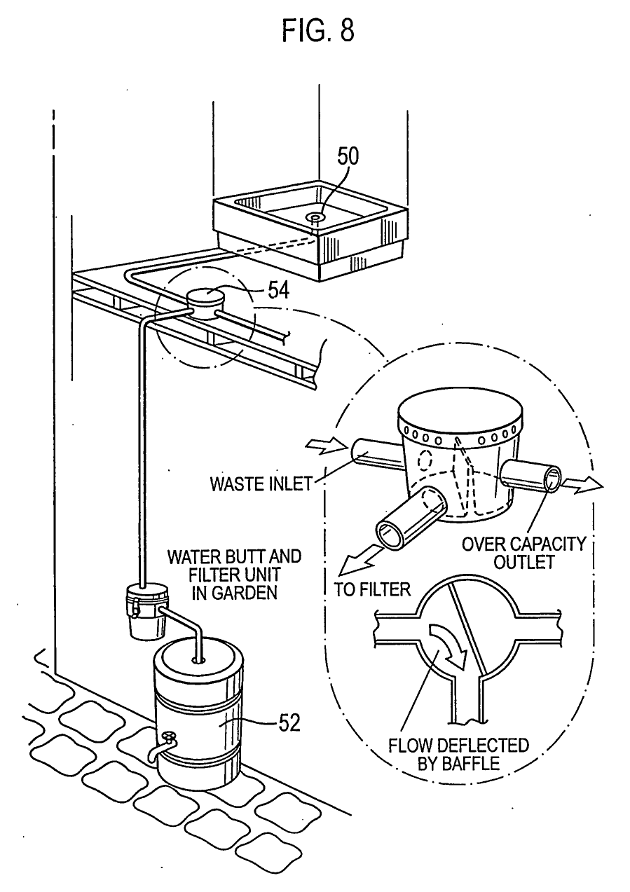

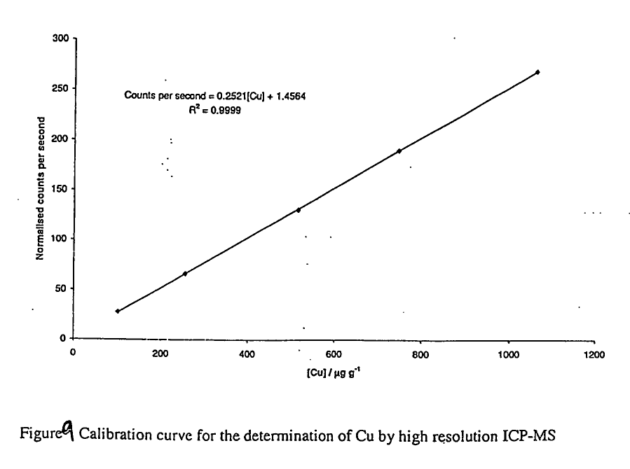

FIG. 8 is a representation of a grey water recycling system including the filter of FIGS. 5, 6 and 7;

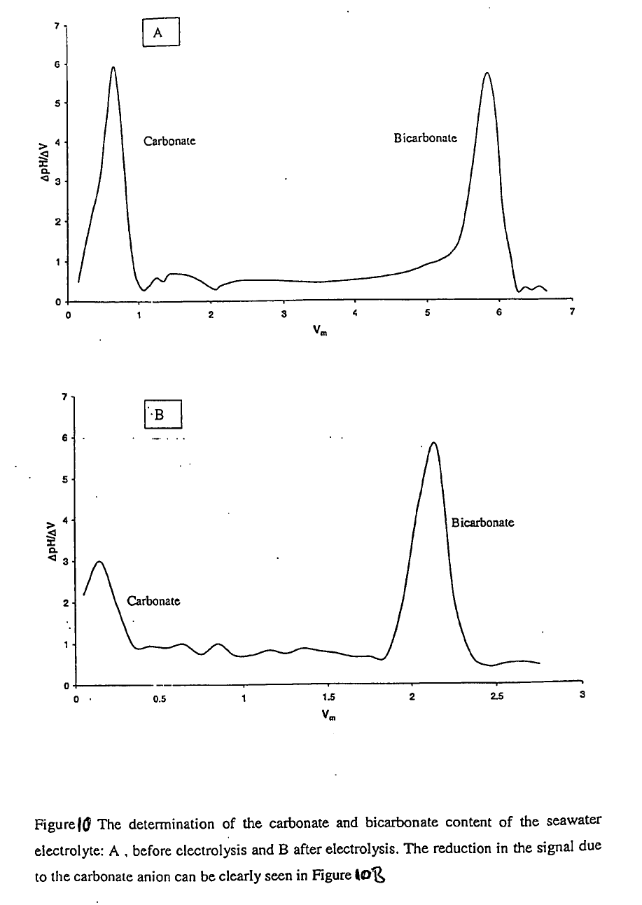

FIG. 9 is a calibration curve for the determination of Cu by high resolution ICP-MS.

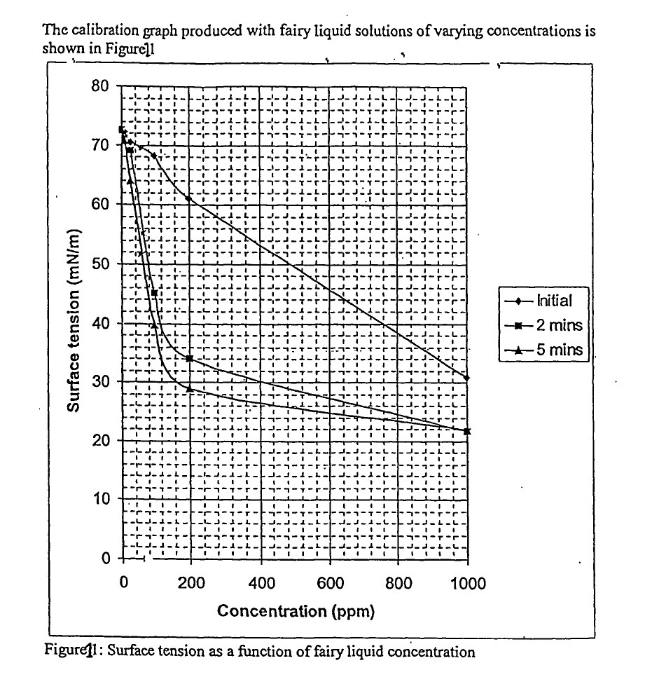

FIG. 10 shows the determination of a carbonate and bicarbonate content of seawater electrolyte

FIG. 11 shows a plot of surface tension as a function of fairy Liquid™ concentration.

Table 1 sets out the operating conditions for a VG Axiom ICP-MS;

Table 2 sets out the elemental composition of a filter medium, 15 mm domestic copper pipe and seawater electrolyte pre and post electrolysis.

Table 3 sets out a Carbon, Hydrogen and Nitrogen analysis of a filter medium;

Table 4 sets out the main elemental composition of filter medium;

Table 5 sets out a number of surface tension measurements.

Referring firstly to FIGS. 1 and 2, the filter apparatus according to a preferred embodiment of the present invention comprises a cylindrical housing 2 having a central perforated filter plate 4 mounted approximately halfway along its length. The filter plate is held in position by locating rings 6 and 8 positioned above and below it, with a suitable resilient sealing ring 10 positioned between the periphery of the filter plate and the lower supporting ring 8.

The upper locating ring 6 is provided with a pair of diametrically opposed, outwardly projecting locating ears 12 which are arranged to form a “bayonet-type” connection with the filter body, by cooperating with suitably formed recesses (not shown) in the inner wall of the filter body.

In order to enable the locating ring to be locked into the body, a pair of inwardly projecting location lugs 14 are arranged at a position which is offset by 90° from the position of the locating ears 12, and each lug 14 is provided with an aperture 16 for inserting one of the legs 18 of an assembly key 20 shown diagrammatically in FIG. 3.

The sealing ring 10 preferably has a resilient or spring-like structure, so that the locating ring 6 can be locked down, by means of its locating ears, and the sealing ring 10 will then hold it resiliently in position.

Wads of nylon mesh 22 are also packed into the filter body, above and below the perforated filter plate, so as to provide a support for a filtering medium, as explained in more detail below.

The lower end of the filter body is provided with an outlet pipe illustrated diagrammatically at 24, and an inlet pipe 26 is connected to the upper end through an aperture in a screw cap 28. The cap is located in position by means of fixing bolts 30 which are screwed into external lugs 32 at diametrically opposed positions on the outside of the filter body.

The cap 28 is also provided with a downwardly extending skirt 34 which projects into the upper end of the body of the filter, so as to seal against a sealing ring 36 inside the upper edge of the body.

In use, the nylon mesh wadding is coated with a special filter medium, the preparation of which is explained below, and the filter body is assembled with the perforated filter plate locked into position between the locating rings 6 and 8 using the bayonet type fixing described above. As “grey” water passes through the filter body, the filter medium acts to remove soap and accompanying scum from the water, so that the flow from the outlet is quite clear.

FIG. 4 illustrates an apparatus for producing the filter medium, by electrolysis of sea water. A quantity of approximately five gallons of sea water is placed in a tank, in which there is immersed an assembly of electrodes as illustrated in plan view in the Figure. This consists of eight circumferentially-spaced copper tubes 40, connected to the positive side of a 12 volt DC supply so as to form anodes, and a centrally-mounted iron cathode 42. This arrangement results in a current of 3.5 to 4.5 amps flowing, and after a period of about four hours, this produces a sedimentary solution which can be removed from a tank and strained to remove excess liquid. The copper anode may for example be comprised of domestic copper tubing.

After the sediment has been left for a suitable length of time to coagulate and set, it can be thinly spread over the nylon mesh material, so as to be ready for use in the filter assembly.

FIGS. 5 to 7 illustrate an alternative embodiment of a filter apparatus.

As shown in FIG. 5 the filter apparatus is provided with a housing 2, a cap 44, an inlet pipe 26 and an outlet pipe 24. A clamp system 46 is provided for releasably locking the cap 44 onto the body of the filter apparatus. The cap 44 and the body are adapted so that the interface between them forms a watertight seal 48 when the cap 44 is locked onto the body.

As shown in FIG. 6 a plurality of filter plates 4 are provided in series. This increases the quantity of filter medium the grey water comes into contact with when compared to an apparatus having just on filter plate.

Grey water enters the filter apparatus through the inlet pipe 26, the grey water then passes through the filter plates 4 and the nylon mesh 22 having filter medium supported thereon and exits the apparatus through the outlet pipe 24.

Each filter plate 4 is releasably fitted into the housing 2 allowing replacement of one or more of the filter plates 4 and the nylon mesh 22 having filter medium supported thereon.

An embodiment of a grey water recycling apparatus is illustrated in FIG. 8. There is provided a grey water source, in the illustrated case a shower drain 50; piping connecting the shower drain 50 to a filter apparatus in accordance with the invention; and a water butt 52 for storing the filtered grey water.

It will be understood that there may be provided alternative grey water sources such as a bath or wash basin and more than one source per filter.

A baffle unit 54, is provided in the piping allowing diversion of excess grey water when the capacity of the filter apparatus is exceeded. This prevents grey water backing up into the source when there is an excessive flow to the filter.

In the embodiment illustrated in FIG. 8 the grey water is forced through the filter under the weight of the water in the piping. Alternatively a pump may be used to force grey water through the filter.

Two investigations into the composition of examples of the sediment forming the filter medium have been carried out. Details of the first investigation are set out below.

The sample subjected to chemical composition analysis arose as a solid product from the electrolysis of domestic 15 mm copper (Cu) pipe, using locally collected seawater as the electrolyte, and a steel cathode. The resulting compound(s), hereinafter referred to as the filter medium was blue/green in appearance and saturated with an aqueous liquid. The method employed to produce the filter medium is similar to electrolytic refining. Samples of the copper pipe used as the anode and seawater, both pre and post electrolysis were also provided for analysis.

Inductively Coupled Plasma Mass Spectrometry Analysis

Three sub samples of the filter medium were washed in high purity 18 MΩcm⁻¹ distilled, deionised water (DDW, Elgastat Maxima, Elga Ltd, High Wycombe, UK). Each of these washed sub samples was then dried to a constant mass at 80° C. for 24 hours. Subsequently, approximately 0.2 g of dried product from each sub sample was accurately weighed, dissolved in approximately 20 g of accurately weighed 10% HNO₃ (Aristar Grade, BDH, Poole, UK). The metal content of these samples was determined by Inductively Coupled Plasma Mass Spectrometry (ICP-MS). The elemental composition of 15 mm domestic Cu pipe was also determined by ICP-MS. For this analysis approximately 1.5 g of Cu pipe was accurately weighed and dissolved in approximately 6 g of concentrated HNO₃ (Aristar Grade, BDH) and diluted gravimetrically to approximately 135 g with DDW prior to analysis.

There are a number of potential isobaric interferents, which arise from polyatomic ions formed in the plasma and interface region, for the analytes of interest. In order to overcome these potential sources of error a VG Axoim (Thermo Elemental, Winsford, UK) high resolution ICP-MS was used for all trace analyses. Typical operating conditions are shown in Table 1. A series of multi-element calibration standards containing the elements of interest, shown in Table 1, was prepared from 10,000 μg g⁻¹ Spectrosol plasma standards (all purchased from BDH). Indium was added to all calibration standards and samples as an internal standard to account for instrumental drift.

FIG. 9 shows a typical calibration curve, in all cases R² values were 0.9975 or better. Seawater samples were diluted by a factor of ten to reduce the chances of the nebuliser clogging due to a high suspended solid loading. The analysis of seawater by ICP-MS can prove problematic due to matrix effects. Therefore, CASS-4 certified reference material (National Research Council, Canada) was also analysed as check for accuracy.

Seawater Alkalinity Analysis

The alkalinity, a measure of the carbonate concentration, of the pre and post electrolysis seawater samples was measured by a pH titration against sulphuric acid. A 60 ml sample of seawater was acidified by the addition of consecutive 100 μl aliquots of a 0.01 M H₂SO₄ solution, prepared by diluting concentrated H₂SO₄ (BDH Aristar Grade) with DDW. The pH of the seawater sample was recorded after the addition of each aliquot of H₂SO₄. Each seawater sample was analysed in triplicate.

Counter Anion Tests

In order to determine the counter anion a series of tests were performed on sub samples of the dried filter medium. To determine the presence of the carbonate anion (CO₃²⁻) approximately 200 mg of the filter medium was placed in a test tube fitted with a gas liberation device. Subsequently, 0.5 ml of 6 molar HCl (Aristar Grade, BDH) was added to the test tube. The resulting gasses were bubbled through a saturated solution of barium hydroxide (Ba(OH)₂). A second sub sample, again of approximately 200 mg, was used to test for the presence of the sulphate anion (SO₄²⁻) by acidification with 6 M HCl followed by the addition of a few drops of 0.2 M BaCl₂ solution. The presence of the hydroxide anion (OH) was tested for by dissolving the filter medium (200 mg) in an ammonia solution (Aristar Grade, BDH).

Carbon, Hydrogen and Nitrogen Analysis

The presence of C, H, and N in the filter medium was determined using a EA1110 CHNS analyser (CE Instruments, Milan, Italy). Three sub samples of approximately 100 mg each were accurately weighed into combustion capsules for analysis. Three separate sub samples of PACS-1 CRM (National Research Council of Canada, Ottawa, Canada) of approximately 100 mg each were also quantified as a check on analytical accuracy.

ICP-MS Analysis

Filter Medium

An initial scan for all of the elements (Except C, H, N, O and Ar) showed significant quantities of sodium (Na), magnesium (Mg), sulphur (S), calcium (Ca), iron (Fe), copper (Cu), silver (Ag), tin (Sn), antimony (Sb), iodine (I), barium (Ba), mercury (Hg), lead (Pb) and uranium (U) in the filter medium. Subsequently, the amounts of these elements in the filter medium were accurately determined, by conventional external calibration, using high resolution ICP-MS. The filter medium was found to be 45.4% copper by mass, with lesser amounts of the other elements present. Table 2 shows the percentage composition of the filter medium for all of the elements of interest.

Domestic Copper Pipe

A sample of domestic 15 mm Cu pipe was digested in concentrated HNO₃ and the elemental composition determined by high resolution ICP-MS in the same manner as the filter medium. Table 2 shows the elemental composition of the copper pipe.

Pre and Post Electrolysis Seawater

Samples of the seawater used as the electrolyte during the production of the filter medium were also provided for analysis. The analytes of interest in these samples were measured by high resolution ICP-MS by conventional external calibration. Table 2 shows the results of these analytes, no significant differences in the elemental composition of the pre and post electrolysis samples was detected.

Seawater Alkalinity Analysis

The carbonate and bicarbonate concentrations in the pre and post use seawater electrolyte samples was measured by acidification with H₂SO₄. A plot of the change in pH/volume of acid added (ΔpH/ΔVm) versus the volume of acid added (Vm) allows the calculation of the carbonate and bicarbonate content from the peak maxima. FIG. 10 shows the results of these experiments. FIG. 10A shows the pH titration for the carbonate/bicarbonate content of the seawater electrolyte before use. The reduction in the signal due to the carbonate anion can be clearly seen in FIG. 10B, the pH titration for the carbonate/bicarbonate content of the seawater electrolyte after use. The carbonate concentration fell from 2.2×10⁻⁴ moles per litre in the pre use seawater to 0.5×10⁻⁴ moles per litre in the post electrolysis seawater. The initial pH of the seawater also fell, pre and post use, from 8.03 to 7.7.

Counter Anion Tests

Three separate experiments were performed on the filter medium to determine the counter anion. Firstly, the presence of carbonate was determined by sample acidification and bubbling the liberated gas(es) through saturated barium hydroxide. Acidification of the filter material liberated a colourless, odourless gas followed by a white precipitate, indicating the presence of the carbonate anion (CO₃²⁻). Equations 1 and 2 show the reaction scheme. The second test was designed to test for the presence of the sulphate anion, SO₄²⁻. No precipitate was observed during this analysis, therefore, the sample does not contain the sulphate anion.

CO₃²⁻(aq)+2H⁺(aq)→+CO₂(g)+H₂O(l) Equation 1

CO₂(g)+Ba²⁺(aq)+20H(aq)−>BaCO₃(s)+H₂O(l) Equation 2

Finally, a separate sub sample of the filter medium was dissolved in a concentrated ammonia solution. Upon dissolution the clear ammonia solution changed colour to an intense blue, indicating the presence of copper hydroxide (Cu(OH)₂). During this test not all of the filter medium dissolved, approximately 50 mg of the filter medium was recovered, dried and tested for the CO₃² anion, which proved positive.

Carbon, Hydrogen and Nitrogen Analysis

The carbon (C), hydrogen (H) and nitrogen (N) content in three sub samples of the filter medium were determined by combustion analysis. C, H, and N, were also determined in NRCC PACS 1 CRM for quality assurance purposes. Table 3 shows the results of these analyses, the sample of the filter medium supplied is composed of 2.85% carbon and 1.1% hydrogen. No nitrogen was detected in the filter medium.

Identification of the Filter Medium

ICP-MS analysis of the filter medium has shown that it comprises 45% by mass of copper, with 1.1% by mass composed of other metallic elements as shown in Table 2. A good correlation was observed between the elemental composition of the 15 mm domestic copper pipe, the electrolysis starting material, and the elements found in the filter medium (Table 2). The composition of the seawater, which was used as the electrolyte in the filter medium manufacturing process, did not change significantly from the pre to the post electrolysis sample with respect to the elements found in the filter medium. However, the carbonate concentration and the pH of the seawater fell during the manufacturing process. This indicated that the filter medium contained the carbonate anion, and possibly the OH— anion, the removal of which from the seawater would cause a fall in the pH.

Subsequently, the identity of the counter anion was confirmed by two separate procedures. Firstly, carbon dioxide (CO₂) was liberated when the filter medium dissolved in hydrochloric acid, this indicated the presence of the carbonate anion, CO₃²⁻. Secondly, an intense azure blue colour was observed when the filter medium was dissolved in ammonia, this indicated the presence of the hydroxide anion, OH—. Therefore, the sample provided which results from the electrolysis of domestic 15 mm copper pipe with seawater as the electrolyte, is a mixture of copper carbonate (CuCO₃) and copper hydroxide (Cu(OH)₂). The relative proportions of these two compounds in the sample presented for analysis was approximately 70% Cu(OH)₂ and 30% CuCO₃, based on the relative proportions of carbon and hydrogen present in the filter medium, as each copper species contains only one of these elements.

It should be noted that the chemical form of the other elements present in the filter medium could not be determined due to their low concentrations. However, it can be surmised that these metals are in a relatively insoluble form, either the carbonate, hydroxide, oxide or sulphate species dependent on the metal. Which metal is in which form will be dependent on the solubility of the individual metal/counter anion species in seawater.

### CONCLUSIONS

The filter medium has been identified as a mixture of copper hydroxide and copper carbonate, with lesser amounts of other metallic species. The relative proportions of the two copper species was calculated as 70:30 from the experimental results obtained.

The filter medium was manufactured via the electrolysis of domestic 15 mm copper pipe, which was the anode in the electrolytic cell, with seawater as the electrolyte. When tap water is used as the electrolyte little or no anode sludge is formed, i.e. the nature of the electrolyte appears to control the process of anode sludge formation. The pH and alkalinity of seawater is higher than that of tap water and as such has a lower capacity to retain the copper ions than tap water. Hence, the seawater has little spare capacity to retain the copper ions released from the anode under electrolysis when compared with tap water. Therefore, insoluble copper, and other metal ions for which seawater is already saturated, form insoluble compounds with the various anion species present in seawater. Thus, no anode sludge is formed when tap water is employed as the electrolyte as the majority of the sacrificial copper anode remains dissolved in the electrolyte and, as the anion concentration of tap water is significantly lower than that of tap water, insoluble species do not form as readily.

The details of the second analysis are set out below.

### BACKGROUND INFORMATION

The tested sample was a blue paste-like material from the electrolysis of seawater using copper electrodes.

The aim of this testwork was as follows:
a) To conduct a brief survey of grey-water treatment systems
b) To obtain more information on the composition of the product generated by Aquastore
c) To quantitatively determine how effective the filter system removed soap from grey water

Grey-Water Treatment

The sources of grey-water in this investigation were baths, showers and hand-wash basins. Characteristic impurities/problems within this water source are:
Bacteria
Hair
Odour
Heat
Oils and greases
Soaps
Suspended solids/turbidity
Oxygen demand

Analyses Performed on the Filter Medium

A sample of the blue coloured paste-like material (the filter medium) was provided for analysis. The analyses performed included a particle size determination, elemental analysis using X-ray fluorescence (XRF), mineralogical determination using X-ray diffraction and solubility in acid.

a) Particle Size Analysis
The size analysis of the sample was determined using a Malvern laser sizer. The mean particle size was 260 μm (66%). The sample did contain some very fine particles with 13.5% less than 10 μm. The full size analysis data is shown in Appendix A.

b) Elemental Analysis by XRF
The sample was dried at 40° C. before the powder was analysed under a helium path with a semi-quantitative program using a Bruker S4 Pioneer XRF analyser.

The principle oxide components are shown in Table 4 with the full analysis shown in Appendix B.

c) Mineralogical Analysis by XRD
The dried sample was analysed using a Siemens D5000 Diffractometer. The full XRD trace is shown in Appendix C. The technique is only capable of identifying crystalline components that make up more than 5% of the sample. The three main components that were identified were para-atacamite (Cu₂(OH)₃Cl), halite (NaCl) and tolbachite. Of these components only the para-atacamite is insoluble in water. This is a naturally occurring mineral that contains 59.4% copper.
d) Solubility in Concentrated Hydrochloric Acid
The sample was readily soluble in concentrated hydrochloric acid producing a bright green solution.

Determination of the Soap Removal Achieved by a Filter Containing the Filter Medium

A test solution containing 30 cm³ of fairly Liquid™ detergent and 4500 cm³ of tap water (equivalent to 6623 ppm). The majority of this solution was passed through a filter containing the filter medium. Samples of the solution before and after treatment were collected in glass bottles for analysis.

The concentration of the contained detergent in the water sample would affect the surface tension of the sample. The surface tension of both the untreated and treated water samples were compared to standards produced in the laboratory. The pendant drop method was used to measure surface tension using the FTA 2000 instrument. For each solution three measurements were taken immediately on droplet formation and after 2 and 5 minutes relaxation. As expected the surface tension reduced with time as the surfactant molecules migrated to the air-liquid interface.

The calibration graph produced with fairy Liquid™ solutions of varying concentrations is shown in FIG. 11.

The measurements made with the two samples provided are given in Table 5.

The tests show that discrimination of concentration using surface tension as an indicator is only possible when the concentration is <200 ppm. Using the calibration graph the concentration of fairy Liquid™ in the solution after filtration is approximately 60 ppm. This is less than 1% of the original concentration, which equates to 99% removal.

GENERAL CONCLUSION

1. The analytical evidence suggests that the major component in the filter medium product is the naturally occurring mineral para-atacamite.

2. Surface tension measurement can be used to estimate the concentration of soap in water in the concentration range 0-200 ppm. It should be possible to determine higher concentrations by dilution.

3. The majority of soap (99%) was removed by a single pass through the filter containing the filter medium.

TABLE 1
Operating conditions for the VG Axiom ICP-MS
VG Axiom MC-SF-ICP-MS Operating Conditions

| | | | |
|---|---|---|---|
| RF Forward Power (W) | 1400 | Plasma gas (1 min⁻¹) | 14 |
| Reflected Power (W) | ≦10 | Auxiliary gas (1 min⁻¹) | 0.85 |
| Resolution | 3000 | Nebuliser gas (1 min⁻¹) | 0.72 |
| Dwell Time (ms) | 100 | Points per Peak | 10 |

| | |
|---|---|
| Spray Chamber | Coupled cyclonic and bead impact, cooled to 5° C. |
| Torch | Fassel Quartz |
| Sampler and Skimmer Cones | Ni |
| Nebuliser | Glass Expansion 0.2 ml/min Micromist |
| Ions Monitored | ²³Na, ²⁴Mg, ³²S, ⁴⁴Ca, ⁵⁶Fe, ⁶³Cu, ¹⁰⁷Ag, ¹¹⁵In, ¹²⁰Sn, ¹²¹Sb, ¹²⁷I, |
| | ¹³⁸Ba, ²⁰²Hg, ²⁰⁸Pb, ²³⁸U |

TABLE 2
Elemental composition of the Filter Medium, 15 mm domestic copper
pipe, and the seawater electrolyte pre and post electrolysis

| | | Domestic 15 | | | | |
|---|---|---|---|---|---|---|
| | Filter | mm Copper | Seawater | | | CASS-4 |
| | Medium | Pipe | before | Seawater | | Certified |
| | Composition | Composition | use | after use | CASS-4 | values |
| Element | (%) | (%) | (μg g⁻¹) | (μg g⁻¹) | (μg l⁻¹) | (μg l⁻¹) |
| Cu | 45 | 96 | 3.6 | 3.7 | 0.61 | 0.592 |
| Mg | 0.57 | 0.3 | 490 | 497 | | |
| Ca | 0.26 | 0.4 | 283 | 279 | | |
| S | 0.09 | 0.3 | 397 | 392 | | |
| Fe | 0.05 | 0.3 | 2.6 | 2.5 | 0.69 | 0.713 |
| Na | 0.05 | 0.1 | 3855 | 3910 | | |
| Ba | 0.02 | 0.4 | 1.9 | 1.9 | | |
| Hg | 0.01 | 0.4 | 1.6 | 1.6 | | |
| U | 0.01 | 0.4 | 1.6 | 1.6 | 2.9 | 3 |
| I | 0.01 | 0.3 | 1.4 | 1.4 | | |
| Sn | 0.01 | 0.3 | 1.2 | 1.2 | | |
| Sb | 0.01 | 0.2 | 0.92 | 0.92 | | |
| Pb | 0.01 | 0.1 | 0.8 | 0.8 | | |
| Ag | 0.01 | 0.5 | 0.65 | 0.64 | | |
| C | 2.5 | | | | | |
| H | 1.4 | | | | | |
| N | 0 | | | | | |

TABLE 3
Carbon, hydrogen and nitrogen analysis
of the Filter Medium and PACS 1 CRM

| Sample | % C | % H | % N |
|---|---|---|---|
| CRM PACS1 | 3.63 | 0.98 | 0.28 |
| CRM PACS2 | 3.68 | 0.95 | 0.25 |
| CRM PACS3 | 3.62 | 0.96 | 0.27 |
| Filter Medium 1 | 2.10 | 1.21 | 0 |
| Filter Medium 2 | 4.12 | 0.90 | 0 |
| Filter Medium 3 | 2.22 | 1.31 | 0 |

Mean Values

| | | | |
|---|---|---|---|
| PACS 1 | 3.64 | 1.0 | 0.3 |
| Filter Medium | 2.85 | 1.1 | 0.0 |
| PACS 1 Certified Value | 3.69 | | |

TABLE 4
Main elemental composition

| Oxide/element | % (by mass) |
|---|---|
| CuO | 61.6 |
| Cl | 16.6 |
| Na₂O | 8.99 |
| MgO | 6.03 |
| SO₃ | 2.87 |
| CaO | 1.86 |
| Fe₂O₃ | 0.93 |

TABLE 5
Surface tension measurements on Filter Medium

| | Surface tension (mN/m) | | |
|---|---|---|---|
| Sample | Initial | 2 minutes | 5 minutes |
| Before treatment | 24.8 | Not done | Not done |
| After treatment | 69.5 | 55.0 | 51.9 |

APPENDIX B
Printed by Eval on 24 Jan. 2005 11:20:39
Sample: Pascoe
Sample measured on 19 Jan. 2005 09:17:50

| F | Na2O | MgO | Al2O3 | SiO2 | P2O5 | SO3 |
|---|---|---|---|---|---|---|
| | 8.9 KCps | 21.7 KCps | 0.4 KCps | 1.6 KCps | 0.2 KCps | 32.5 KCps |
| 0.0% | 8.99% | 6.03% | 0.0990% | 0.360% | 0.0379% | 2.87% |

| Cl | K2O | CaO | Sc2O3 | TiO2 | V2O5 | Cr2O3 |
|---|---|---|---|---|---|---|
| 194.2 KCps | 9.4 KCps | 36.6 KCps | | | 0.1 KCps | 0.3 KCps |
| 16.6% | 0.440% | 1.86% | 0.0% | 0.0% | 0.00386% | 0.00734% |

| MnO | Fe2O3 | CoO | NiO | CuO | ZnO | Ga2O3 |
|---|---|---|---|---|---|---|
| 0.4 KCps | 95.9 KCps | 4.3 KCps | | 8098.6 KCps | | −0.1 KCps |
| 0.00513% | 0.930% | 0.0244% | 0.0% | 61.6% | 0.0% | 0.0% |

| GeO2 | As2O3 | SeO2 | Br | Rb2O | SrO | Y2O3 |
|---|---|---|---|---|---|---|
| | | | 12.3 KCps | | 6.5 KCps | |
| 0.0% | 0.0% | 0.0% | 0.0866% | 0.0% | 0.0339% | 0.0% |

| ZrO2 | Nb2O5 | MoO3 | Ru | Rh | Pd | Ag |
|---|---|---|---|---|---|---|
| 1.2 KCps | | | | 0.1 KCps | | |
| 000404% | 0.0% | 0.0% | 0.0% | 0.00737% | 0.0% | 0.0% |

| CdO | In2O3 | SnO2 | Sb2O3 | TeO2 | I | Cs2O |
|---|---|---|---|---|---|---|
| 0.0% | 0.0% | 0.0% | 0.0% | 0.0% | 0.0% | 0.0% |

| BaO | La2O3 | CeO2 | Pr6O11 | Nd2O3 | Sm2O3 | Eu2O3 |
|---|---|---|---|---|---|---|
| | | 0.1 KCps | | | | |
| 0.0% | 0.0% | 0.0141% | 0.0% | 0.0% | 0.0% | 0.0% |

| Gd2O3 | Tb4O7 | Dy2O3 | Ho2O3 | Er2O3 | Tm2O3 | Yb2O3 |
|---|---|---|---|---|---|---|
| | 0.4 KCps | | | 16.4 KCps | | |
| 0.0% | 3.00303% | 0.0% | 0.0% | 0.0% | 0.0% | 0.0% |

| Lu2O3 | HfO2 | Ta2O5 | WO3 | Re | Os | Ir |
|---|---|---|---|---|---|---|
| 6.5 KCps | 55.9 KCps | | | −0.0 KCps | 1461.5 KCps | |
| 0.0% | 0.0% | 0.0% | 0.0% | 0.0% | 0.0% | 0.0% |

| Pt | Au | Hg | Tl | PbO | Bi2O3 | ThO2 |
|---|---|---|---|---|---|---|
| 0.0% | 0.0% | 0.0% | 0.0% | 0.0% | 0.0% | 0.0% |

| UO2 | Compton | Rayleigh | Norm. |
|---|---|---|---|
| 0.0% | 1.01 | 1.13 | 100.00% |

1-15. (canceled)

16. A method of filtering grey water for recycling, which comprises passing grey water to be filtered, through a filter assembly including a support mesh or blanket holding a material selected from the group consisting of:
a sedimentary material produced by electrolysis of sea water, paratacamite, acamite or botallackite.

17. A filter assembly including a cylindrical housing, a perforated filter plate and at least one mesh or blanket member supported by the filter plate, which holds a sedimentary material produced by electrolysis of sea water.

18. A filter assembly according to claim 17 including a series of mesh or blanket members arranged in a stack so as to provide multi-stage filtration.

19. A filter assembly according to claim 18 in which the mesh or blanket comprises nylon wadding.

20. A method of producing a filter medium for filtering grey water for recycling, the method comprising subjecting an aqueous solution containing chloride ions to electrolysis using at least one copper anode.

21. The method according to claim 20 wherein the aqueous solution has 0₂ dissolved therein.

22. The method according to claim 20, wherein said aqueous solution is sea water, whereby a sediment is produced which can be utilized, with a suitable support means, to form a filter medium.

23. A method according to claim 22 wherein the electrolysis process uses at least one ferrous cathode.

24. A method according to claim 22 in which a volume of approximately five gallons of sea water is subjected to a potential of 12 volts for a period of approximately four hours, to produce a sediment which can be applied to a filter blanket.

25. A filter medium produced by the method of claim 20.

26. A filter medium produced by the method of claim 21.

27. A filter medium produced by the method of claim 22.

28. A filter medium produced by the method of claim 23.

29. A filter medium produced by the method of claim 24.

30. A filter medium for filtering gray water comprised of a material selected from the group consisting of paratacamite, acamite, botallackite, or a compound having the formula Cu₂(OH)₃Cl, CuCO₃ and Cu(OH)₂.

31. A filter medium according to claim 30 wherein the relative proportions of the CuCO₃ and Cu(OH)₂ are 30:70.
